(19) United States
(12) Patent Application Publication
(10) Pub. No.: US 2011/0216933 A1
(43) Pub. Date: Sep. 8, 2011

(54) Elastomer Loudspeaker Box System

(76) Inventor: Quiling Lan, Guangki (CN)

(21) Appl. No.: 13/127,390

(22) PCT Filed: Nov. 23, 2009
(86) PCT No.: PCT/CN2009/075087

§ 371 Date: May 3, 2011

(30) Foreign Application Priority Data
Nov. 28, 2008 (CN) 2008102179203.3

(51) Int. Cl. H04R 1/02

(52) U.S. Cl. 381/386

(57) ABSTRACT

An elastomer loudspeaker box system includes a loudspeaker box, a loudspeaker unit, a baffle and a bottom board. The loudspeaker box is made of elastomer material, and the tube wall of the loudspeaker box is bended to form a box body of corrugated tube shape, whereby the box body of the loudspeaker box is elastic and is retractable freely. The loudspeaker unit is mounted to the baffle. One end of the loudspeaker box is mounted to the baffle, and the other end is closed by the bottom board, whereby the loudspeaker unit, the loudspeaker box and the bottom board cooperatively form a closed box system. So, the loudspeaker unit and the retractable rock movement of box body of the loudspeaker box can produce resonance, and the elastic box body acts as sound radiator to radiate the low frequency, thereby extending the bass response towards low side, increasing the purity of sound, and improving the bass performance.

### FIELD OF THE INVENTION

The present invention relates to the technical field of acoustics, particularly relates to a loudspeaker box system.

### BACKGROUND OF THE INVENTION

To achieve the objects of isolating the front and back sounds of a loudspeaker, preventing the sounds from interfering in each other, and improving the high fidelity of the sounds, currently in the market, a box body of a conventional loudspeaker box generally is made of materials with large rigid and hardness, such as a woody material, flakeboard, fiberboard, plywood, natural stone, artificial stone, marble, concrete, and organic glass. The reason of using these materials, in respect of acoustical properties, is intended to prevent the loudspeaker box board from vibrating, to avoid the excited resonance of the material itself, especially to eliminate ultraharmonics, to prevent the sounds from interfering in each other, to reduce audible coloration, and to increase the purity of sound. The design of such a conventional box body is only used for sound insulation and avoiding acoustic short circuit, since the wall of the box has large rigid, large hardness and no elasticity.

However, in fact, materials with large rigid and hardness have small internal damping and absorb little sound wave due to the physical properties of itself. So, the velocity of sound transmission within the materials is fast. Firstly, the box body made of such materials will excite high frequency excited vibration to produce anharmonic sound, which will cause that the sounds of the loudspeaker interfere in each other and the timbre becomes muddy. Secondly, the bass response design of the loudspeaker box and the system thereof currently mainly has two design forms, namely closed boxes and vented boxes.

The cavity of a conventional closed box is of closed type. After the loudspeaker unit is mounted, the acoustic box of the cavity has big stiffness and small compliance. The minimum resonance frequency Fc of the box body is higher than the resonance frequency of the loudspeaker unit in free space. So, low frequency can not be extended via combining the box body.

A conventional vented box is provided with sound guide holes. The low frequency radiant sound wave can be adjusted via adjusting the size and length of the air duct to change the acoustic mass of the air duct. The sound guide holes provided at the box body not only will transmit the acoustic output of low frequency end, but also will bring about pop noise and the interference of resonance, and will transmit the audible coloration of standing wave that is formed inside the loudspeaker by the material itself of the box body exciting resonance to reflect, which results in muddy low frequency sound.

### SUMMARY OF THE INVENTION

An object of the present invention is to provide an elastomer loudspeaker box system that extends the low frequency characteristic and increases the purity of sound simultaneously.

To achieve the above object, an elastomer loudspeaker box system of the present invention comprises a loudspeaker box, a loudspeaker unit, a baffle and a bottom board. The loudspeaker box is made of elastomer material, and the tube wall of the loudspeaker box is bended to form a box body of corrugated tube shape. The tube wall is preferred to be all bended, and obviously it can also be partially bended, thereby the box body of the loudspeaker box being elastic and being retractable freely. The elastomer material is preferred to be elastic soft rubber, and of course it can also be other elastomer composite material, such as foamed plastic, and elastomer synthetic material. The baffle is preferred to be wood plank or plastic, and of course can be a board of other material. The loudspeaker unit is mounted to the baffle. One end of the loudspeaker box is mounted to the baffle, and the other end is closed by the bottom board, whereby the loudspeaker unit, the loudspeaker box and the bottom board cooperatively form a closed box system. The bottom board is mainly used to close the loudspeaker box to form a closed box system, and can also be used in adjusting the resonant frequency and radiated sound pressure of the loudspeaker box if necessary. By controlling and deploying the mass, size or material of the bottom board, the resonant frequency and radiated sound pressure value of the box body can be effectively changed. The material of the bottom board is preferred to be metal iron plate, and can also be paper or rubber, plastic, etc. And of course, the bottom board and the loudspeaker box can also be integrally formed.

In the above mentioned technical solution, the lengthwise section of the box wall of the loudspeaker box is preferably bended into wave shape or sawtooth shape, such as sine wave or cosine wave, and of course it can also be other shape such as square wave, trapezoidal wave, and triangular wave.

The box wall of the loudspeaker box is preferably provided with small air holes, which are mainly for adjusting the stiffness of the acoustic cavity of the box body, and simultaneously for adjusting the resonance point of the box body to extend the low frequency. Since the acoustic mass inside the holes is light, the action of the holes to radiate sound wave is very weak. The audible coloration of standing wave that is formed by the reflected wave radiated from the holes can be ignored, thereby ensuring the purity of bass. Furthermore, by compressing the box body to let the air to flow out, the volume of the box body can be reduced greatly to be convenient for packaging and carrying.

The shape of the loudspeaker box preferably is cylindrical, and of course it can also be variously tubular, such as a square tube, a triangular tube, a tapered tube, and a cylindrical tube. Or, it can be an assembly of over two pieces of various tubular structures that are of different shape or size.

The loudspeaker unit is preferably mounted to the baffle by bonding or by means of screws.

The loudspeaker box is preferably mounted to the baffle by bonding or by means of screws.

In the above mentioned technical solution, the baffle can also be box-shaped. By adjusting the size of the box-shaped baffle, the volume of the acoustic cavity of the box body can be changed, thereby reducing the nonlinear distortion, extending the bass response towards low side, and improving the low frequency. An inverted tube can also be arranged inside the box-shaped baffle.

The advantages of the present invention are described as following. Firstly, the box body of the present invention has the performance like springs, and combines the action of sound production and vibration force of the loudspeaker unit, and the compression and dilatation of the air inside the cavity. The loudspeaker box stores and releases energy by the deformation of the elastomer material, and utilizes the good elastic displacement value and linear steady-state restoring force of the corrugated tube-shaped box body to drive the elastic box body to retract to produce resonance. The box body acts as a radiator of sound to radiate sound wave. When sound wave is transmitting in an elastomer material, the material has the acoustical property of sound absorption, sound transmission and sound reflection. By adjusting the elastomer material to different materials and formulas, the radiation performance of sound can be convenient and effective to be changed to improve the low frequency. Moreover, the sound wave radiated by the back of the loudspeaker unit is an elastic wave. Utilizing the property that an elastic wave will reduce the speed in a corrugated tube-shaped elastomer, the acoustic compliance of the box body is increased, thereby equivalently increasing the volume of the cavity, reducing the nonlinear distortion, extending the bass response towards low side, increasing the purity of sound, and improving the bass performance. Secondly, the box wall of the box body is bended into wave shape or sawtooth shape, etc., and the elastomer material itself has the physical property of high damping internal loss to be not easy to excite high frequency resonance, thereby being capable of vibration damping, effectively absorbing reflected waves in the acoustic cavity, and improving the purity of sound. Thirdly, via the loudspeaker closed box design, the air inside the cavity is isolated from the outside, and the vibration of the loudspeaker diaphragm will make the air inside the cavity to be repeatedly compressed and dilatated. 1) The box body of the elastomer loudspeaker has elasticity, and the material is soft rubber or other elastomer material. The box wall is provided with bends of wave shape or sawtooth shape. The loudspeaker unit is mounted to the baffle of the box body. The vibration force of the diaphragm of the loudspeaker unit drives the box body to retract, and the box body acts as a sound radiator to radiate low frequency. Since the box body of a conventional loudspeaker is hard rigid wood, or hard plastic, stone, and organic glass, the loudspeaker unit is mounted to the box body, and the force applied to the box body does not make the box body to retract to radiate low frequency. 2) Via the closed box design of the elastomer loudspeaker box system, the force produced by the loudspeaker diaphragm drives the elastic box body to radiate low frequency sound, thereby extending the bass response and improving the bass effect. However, in a conventional closed box, the force produced by the loudspeaker diaphragm is directly applied to the hard box body, which produces high frequency noise and adversely affects the purity of sound. 3) In the closed box design of the elastomer loudspeaker box system, for the elastic box body is involved in the resonance, the impedance response characteristic of the closed box system has two resonant maximum peaks. The tuning frequency of the box body can be adjusted to be lower than the resonant frequency of the loudspeaker unit, thereby extending the low frequency. However, a conventional closed box only has one resonant peak, and the tuning frequency of the box body is higher than the resonant frequency of the loudspeaker unit, which results in failure to extend the low frequency.

The characteristic and the technical solution of the present invention are best understood from the following detailed description with reference to the accompanying figures, but the figures are only for reference and explaining, not to limit the scope of the invention.

### BRIEF DESCRIPTION OF THE DRAWINGS

FIG. 1 is a sectional view showing the internal structure of an elastomer loudspeaker box system in accordance with an embodiment of the present invention;

FIG. 2 is a side elevational view of an elastomer loudspeaker box system in accordance with an embodiment of the present invention;

FIG. 3 is a perspective view of an elastomer loudspeaker box system in accordance with an embodiment of the present invention;

FIG. 4 is similar to FIG. 3 with a portion cutout;

FIG. 5 is a force diagram of the symbolic mechanical system of an elastomer loudspeaker box body;

FIG. 6 is a mechanical circuit diagram of the elastomer loudspeaker box body of the present invention;

FIG. 7 is a schematic diagram of the impedance characteristic curve of the elastomer loudspeaker box system of the present invention and the loudspeaker unit;

FIG. 8 is a schematic diagram of the impedance characteristic curve of a conventional loudspeaker closed box system and the loudspeaker unit;

FIG. 9 is a schematic diagram comparing the impedance characteristic curve of an elastomer loudspeaker box system of the present invention with a conventional loudspeaker closed box system;

FIG. 10 is a schematic diagram comparing the sound pressure characteristic curve of an elastomer loudspeaker box system of the present invention with a conventional loudspeaker closed box system;

FIG. 11a is a sectional view showing the lengthwise section 2 of the box wall of a loudspeaker box being trapezoidal wave;

FIG. 11b is a sectional view showing the lengthwise section 2 of the box wall of a loudspeaker box being triangular wave;

FIG. 11c is a sectional view showing the lengthwise section 2 of the box wall of a loudspeaker box being sine wave;

FIG. 11d is a sectional view showing the lengthwise section 2 of the box wall of a loudspeaker box being sawtooth wave;

FIG. 11e is a sectional view showing the lengthwise section 2 of the box wall of a loudspeaker box being square wave;

FIGS. 12a, 12b, 12c, 12d, and 12e are schematic views showing various tubular loudspeaker boxes;

FIGS. 13a, 13b, and 13c are schematic views showing box-shaped baffles of various shapes; and

FIGS. 14a and 14b are schematic views showing elastomer loudspeaker box systems with two loudspeaker boxes.

### DESCRIPTION OF THE PREFERRED EMBODIMENTS

Hereinafter, the present invention is described detailedly with reference to the accompanying figures.

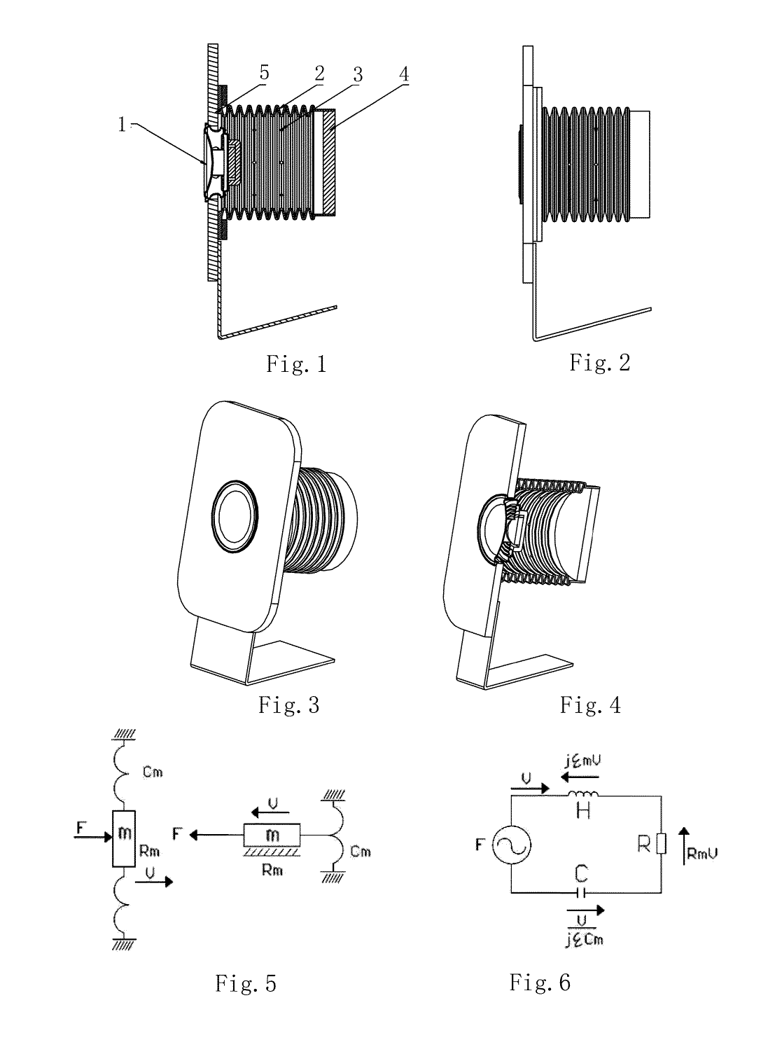

As shown in FIGS. 1-4, an elastomer loudspeaker box system in accordance with an embodiment of the present invention comprises a loudspeaker unit 1, a loudspeaker box 2, a bottom board 4 and a baffle 5. The loudspeaker box 2 has a corrugated tube shape of box body made of elastomer material, of which the lengthwise section of the tube wall is bended to be wave shape. The tube wall is provided with air holes 3. The loudspeaker unit 1 is mounted to the baffle 5 by bonding, and certainly, it can also be mounted by means of screws, etc. At one end of the loudspeaker box 2, the edge of the box body of corrugated tube shape is impacted by shims and then is mounted to the baffle 5 via screws, and certainly it can also be mounted via other means such as bonding. The other end of the loudspeaker 2 is closed by being bonded to the bottom board 4. So, the loudspeaker unit 1, the loudspeaker box 2 and the bottom board 4 cooperatively form a closed box system, and a cavity is defined among the acoustic cavity at the back of the loudspeaker unit 1, the loudspeaker box 2, and the bottom board 4.

In the present embodiment, the material of the loudspeaker box 2 adopts elastic soft rubber, which has the properties such as light weight, being waterproof, good bursting strength and good impact resistance to be convenient for being mounted at places for different purposes. Rubber is a viscoelastic high polymer material, and has internal loss of high damping. The relative molecular weight distribution of rubber matrix is adjustable to be fit for absorbing sound waves of various frequencies. When sound waves come into the rubber, a part of medium high frequency sound wave energy does work to change the vibration of the polymer chains and side groups of the material, so as to achieve the object of absorbing sound and reducing audible coloration; and, a part of comparatively low frequency sound wave energy does idle work, so low frequency is transmitted to improve bass. Certainly, the loudspeaker box 2 can also adopts other elastomer composite material, such as polyurethane (PU) elastomer, high density elastic sponge, rubberized cloth, TPO (thermoplastic elastomer rubber) and so on.

The loudspeaker box 2 has damping effect to be not easy to excite high-order resonance, since the material of the loudspeaker box 2 itself has the physical property of internal loss of high damping. The lengthwise section of the tube wall is wave shape, of which the concavo convex bends can absorb, restrain and improve the messy reflected waves produced inside the box body, so as to reduce audible coloration, reduce harmonic distortion and increase the purity of sound.

The air holes 3 can act as tuning holes, which are mainly for adjusting the stiffness of the acoustic cavity of the box body, and at the same time for adjusting the resonance point of the box body to extend the low frequency. By adjusting the size, arrangement and quantity of the air holes 3, the mechanical compliance of the box body can be changed, and the resonant frequency of the box body can be adjusted to extend low frequency. Also, by compressing the box body to let the air in the box body to flow out via the air holes 3, the box body can be reduced to be convenient for packaging and carrying.

The bottom board 4 is mainly used in a closed loudspeaker box, and can also be used in adjusting the resonant frequency and radiated sound pressure of the loudspeaker box. By controlling and deploying the mass, size or material of the bottom board, the resonant frequency and radiated sound pressure value of the box body can be effectively changed. The material of the bottom board 4 is metal iron plate, and can also be paper or rubber.

The material of the baffle 5 is wood plank, metal or plastic, which is mainly for mounting the loudspeaker unit 1 and the loudspeaker box 2, and is not involved in the radiation of the box body.

FIG. 5 is a force diagram of the symbolic mechanical system of an elastomer loudspeaker box body. As shown in FIG. 5, one end of the spring is fixed, and the other end is connected to the object with its equivalent vibration mass being m. Under the action of driving force F, by being connected to the spring with its equivalent mechanical compliance being C, the object receives the action of equivalent mechanical resistance Rm to resist the object vibration velocity V while the object is moving. And, because one end of the spring is connected to the object, the three components have the same vibration velocity V. So, a series equivalent circuit can be got, that is, as shown in FIG. 6 the mechanical circuit diagram of the elastomer loudspeaker box body.

Via analyzing the circuit, the following formula can be got:

$$V = \frac{F}{Z m} = \frac{F}{{R}_{m} + j \frac{ɛ m - 1}{ɛ {C}_{m}}}$$

Wherein:

ε=2πf

j=\sqrt{−1}

V=vibration velocity

m=equivalent mass of the loudspeaker

Cₘ=equivalent mechanical compliance of the elastomer box body

Rₘ=internal friction caused by the repeated spring deformation, air viscosity resistance, and radiation impedance

F=driving force of the loudspeaker

Zm=mechanical impedance

When the mechanical reactance component of Zm equals to 0, that is

$$\frac{ɛ m - 1}{ɛ {C}_{m}} = 0 ,$$

at this frequency, the vibration velocity

$$V = \frac{F}{{R}_{m}} ;$$

at the two sides of this frequency, V reduces sharply, so as to get the resonance frequency

$${F}_{O} = \frac{1}{2 π \sqrt{m {C}_{m}}} ,$$

in other words, the elastomer box body is involved in the resonance to act as a radiator, thereby radiating the low frequency to improve bass.

An actual test is described below to show the frequency response effect of the present invention. FIG. 1 shows a 36 MM loudspeaker full range unit product. The FO of the unit is 180 HZ, and the unit is mounted to the loudspeaker box being an elastomer. The box body is provided with bends of wave shape, and the box body is elastic and is retractable freely. The material of the box body is soft rubber. The box body is of the design of closed box, and its inside volume is 0.141 L.

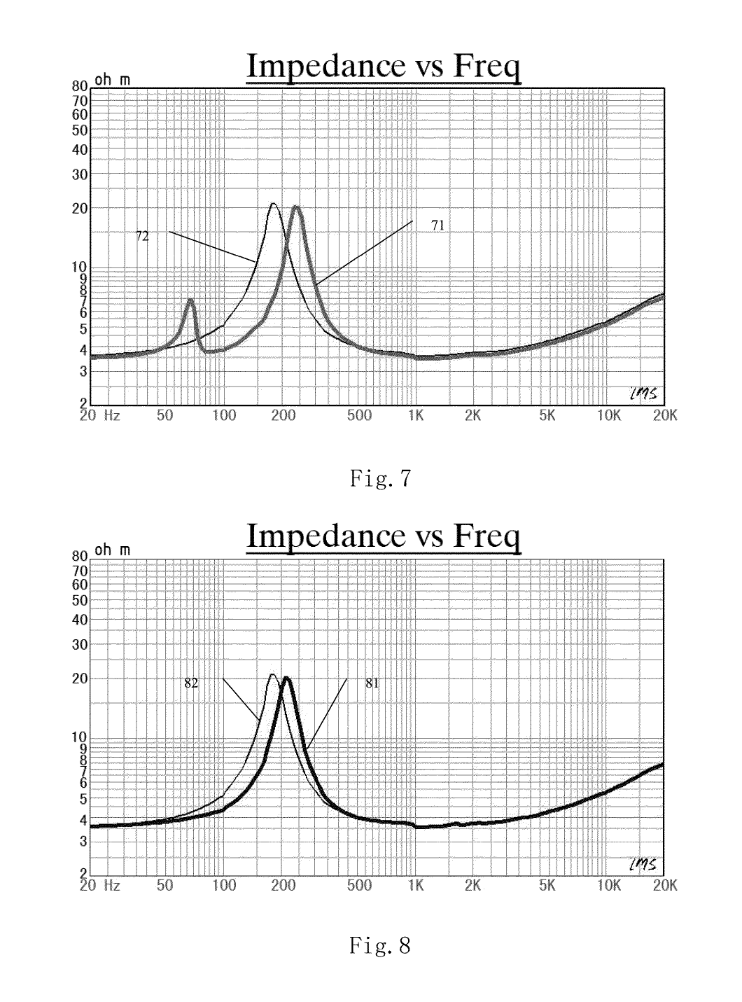

By testing its impedance characteristic, the response is shown in FIG. 7. In FIG. 7, the thick curve 71 is the impedance versus frequency characteristic curve of the elastomer loudspeaker box system, and the thin curve 72 is the impedance versus frequency characteristic curve of the loudspeaker unit. As shown in the figure, the impedance versus frequency characteristic curve of the elastomer loudspeaker box system has two maximum peaks that indicate two resonance circuits. One resonance circuit is the resonance of the closed box loudspeaker unit and the acoustic cavity mechanical compliance, and the other resonance circuit is the resonance of the loudspeaker unit and the elastic box body mechanical compliance, which form a parallel resonant circuit. Also as shown in the figure, the resonant frequency of the box body is 100 HZ, which has extended low frequency. FIG. 8 is a schematic diagram of the impedance characteristic of a conventional loudspeaker closed box system. In FIG. 8, the thick curve 81 is the impedance versus frequency characteristic curve of a traditional loudspeaker closed box system, and the thin curve 82 is the impedance versus frequency characteristic curve of the loudspeaker unit. As shown in the figure, the impedance versus frequency characteristic curve of the conventional loudspeaker closed box system has only one peak that indicates only one resonance circuit. The resonance circuit is the resonance of the loudspeaker unit and the acoustic cavity mechanical compliance. The resonant frequency of the box body is 210 HZ, and the low frequency is shifted up.

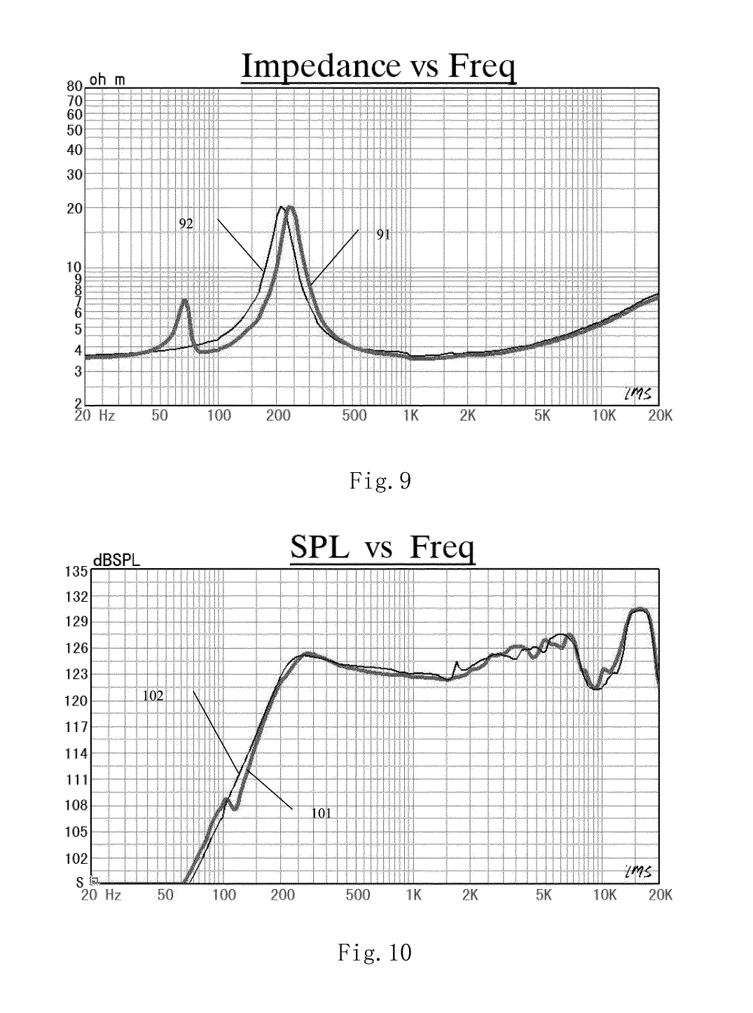

FIG. 9 is a schematic diagram comparing the impedance characteristic of an elastomer loudspeaker box system with a conventional loudspeaker closed box system. In FIG. 9, the thick curve 91 is the impedance versus frequency characteristic curve of the elastomer loudspeaker box system, and the thin curve 92 is the impedance versus frequency characteristic curve of the conventional loudspeaker closed box system. As obviously shown in the figure, the impedance characteristic of the elastomer loudspeaker box has two resonant maximum peaks, and the conventional loudspeaker closed box system only has one. The resonant frequency of the elastomer loudspeaker box body is 100 HZ, and the resonant frequency of the conventional loudspeaker box is 210 HZ. So, the elastomer loudspeaker box extends the low frequency.

FIG. 10 is a schematic diagram comparing the near field sound pressure characteristic of an elastomer loudspeaker box system with a conventional loudspeaker closed box system. In FIG. 10, the thick curve 101 is the sound pressure versus frequency curve of the elastomer loudspeaker box system, and the thin curve 102 is the sound pressure versus frequency curve of the conventional loudspeaker closed box system. As obviously shown in the figure, the sound pressure level of the elastomer loudspeaker box starts being increased at the resonant frequency of 100 HZ, which is 1.5 dB higher than the conventional loudspeaker closed box system, so, the low frequency is extended and the sound pressure is increased.

In summary, the elastomer loudspeaker box system of the present invention, by the mass, the elasticity and the damping control method of its mechanical system and acoustics system, which utilizes the box body as a radiator of sound, can extend the low frequency characteristic and increase the purity of sound.

The above said preferred embodiments of the present invention are described detailedly for those skilled in the art to understand the present invention. But it is to be understood that all the modifications and changes according to the characteristic and spirit of the present invention are involved in the protected scope of the present invention.

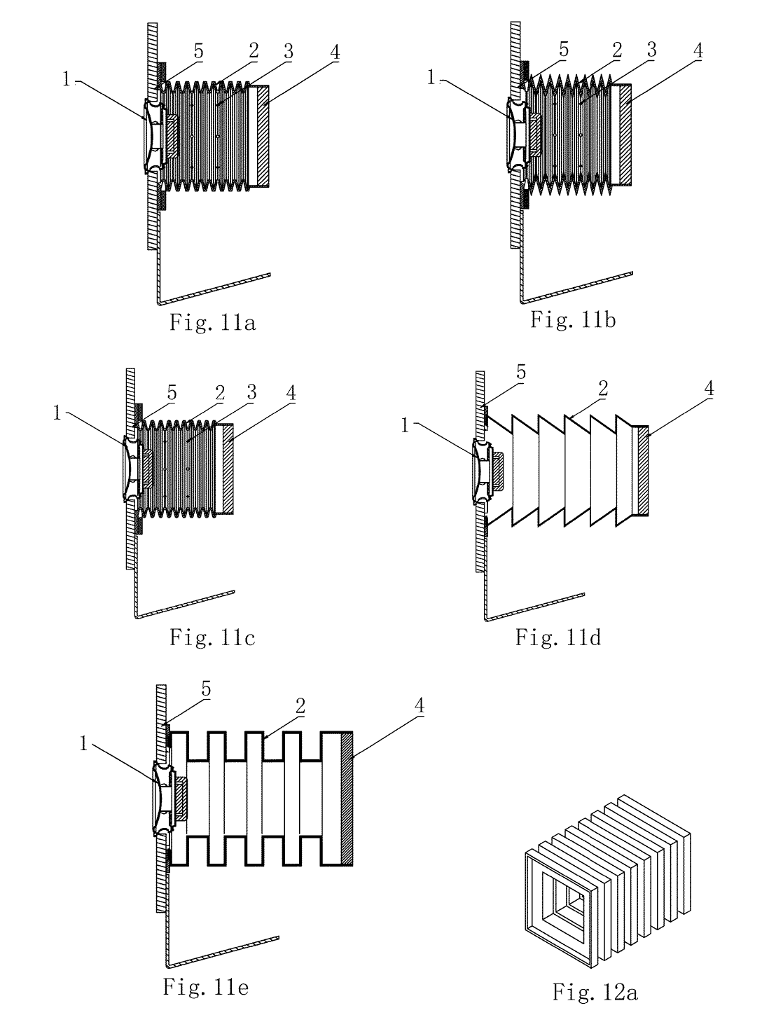

For example, the lengthwise section of the box wall of the loudspeaker box can be bended into different wave shapes. FIGS. 11a-11e in turn show the lengthwise section of the box wall of an elastomer loudspeaker box, and the lengthwise section is bended respectively into different wave shapes, that is, trapezoidal wave, triangular wave, sine wave, sawtooth wave, and square wave.

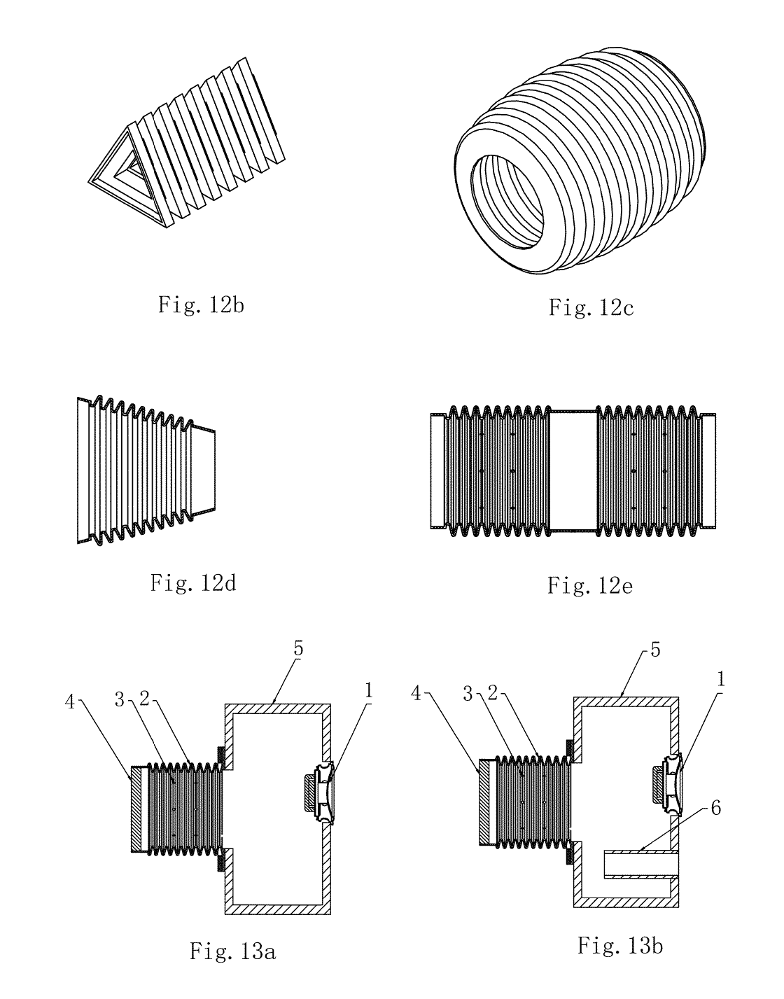

Also, the geometric shape of the elastomer loudspeaker box structure is basically tubular, and the specific outline can be changed with various forms. As shown in FIGS. 12a-12e, the elastomer loudspeaker box in turn is a square tube, a triangular tube, a cylindrical tube, a tapered tube with its caliber being gradually reduced, and an assembly of two pieces of tubes.

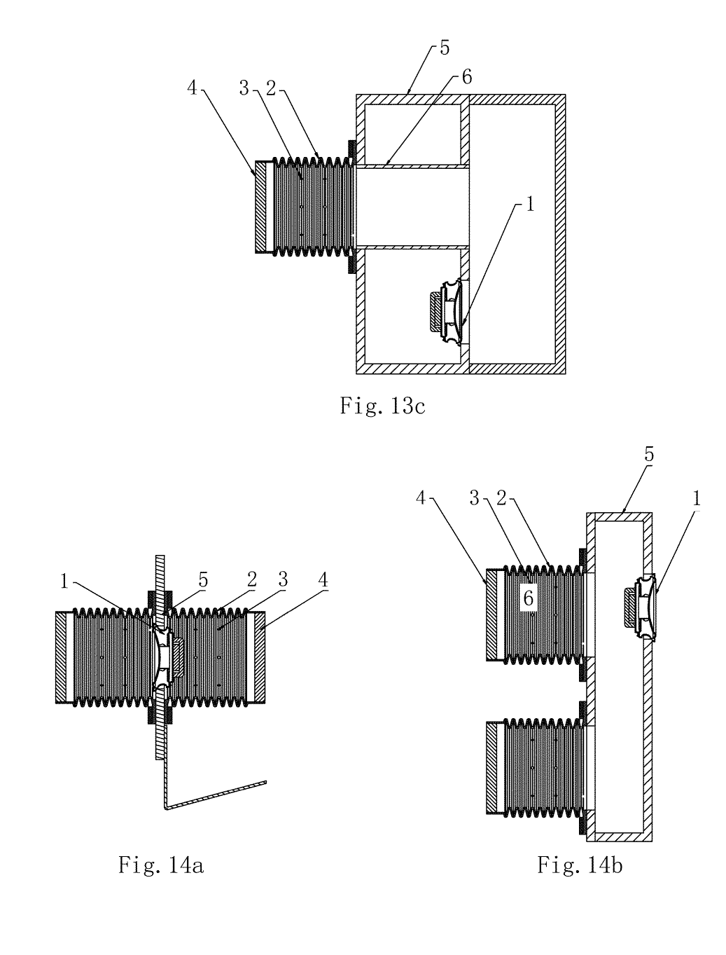

Furthermore, the baffle 5 can be a box-shaped baffle composed of multiple baffles, which is used to be mounted to the loudspeaker unit and the elastomer loudspeaker box. Moreover, the baffle 5 is defined with a cavity thereinin. By adjusting the size of the cavity of the box-shaped baffle, the volume of the acoustic cavity of the box body can be changed, thereby reducing the nonlinear distortion, extending the bass response towards low side, and improving the low frequency. FIGS. 13a-13c show elastomer loudspeaker box systems with a box-shaped baffle, and wherein, an inverted tube 6 is provided inside the box-shaped baffle in FIG. 13b and FIG. 13c.

Moreover, the elastomer loudspeaker box system can also comprise two or even more loudspeaker boxes, and FIGS. 14a and 14b show systems with two loudspeaker boxes made of elastomer.

Although the present invention has been described in detail with above said embodiments, but it is not to limit the scope of the invention. So, all the modifications and changes according to the characteristic and spirit of the present invention, are involved in the protected scope of the invention.

What is claimed is:

1. An elastomer loudspeaker box system comprising a loudspeaker box, a loudspeaker unit, a baffle and a bottom board; the loudspeaker box being made of elastomer material, and the tube wall of the loudspeaker box being bended to form a corrugated tube shape of box body, whereby the box body of the loudspeaker box is elastic and is retractable freely; the loudspeaker unit being mounted to the baffle; one end of the loudspeaker box being mounted to the baffle, and the other end being closed by the bottom board, whereby the loudspeaker unit, the loudspeaker box and the bottom board cooperatively form a closed box system.

2. The elastomer loudspeaker box system of claim 1, wherein the loudspeaker box is formed by more than one piece of corrugated tube shape of box bodies of which the tube wall is bended, and the corrugated tube shape of box bodies made of elastomer material are connected as an assembly.

3. The elastomer loudspeaker box system of claim 1, wherein the lengthwise section of the box wall of the loudspeaker box is bended into wave shape or sawtooth shape.

4. The elastomer loudspeaker box system of claim 3, wherein the box wall of the loudspeaker box is provided with air holes.

5. The elastomer loudspeaker box system of claim 1, wherein the elastomer material is elastic soft rubber.

6. The elastomer loudspeaker box system of claim 5, wherein the loudspeaker unit is mounted to the baffle by bonding or by means of screws.

7. The elastomer loudspeaker box system of claim 6, wherein the loudspeaker box is mounted to the baffle by bonding or by means of screws.

8. The elastomer loudspeaker box system of claim 7, wherein the shape of the loudspeaker box is cylindrical.

9. The elastomer loudspeaker box system of claim 7, wherein the baffle is box-shaped.

10. The elastomer loudspeaker box system of claim 9, wherein an inverted tube is arranged inside the box-shaped baffle.
